(19) United States
(12) Patent Application Publication
(10) Pub. No.: US 2014/0009570 A1
(43) Pub. Date: Jan. 9, 2014

(54) SYSTEMS AND METHODS FOR CAPTURE AND DISPLAY OF FLEX-FOCUS PANORAMAS

(71) Applicant: TOURWRIST, INC., San Francisco, CA (US)

(72) Inventors: Alexander I. Gorstan, Owings Mills, MD (US); Charles Robert Armstrong, San Francisco, CA (US)

(73) Assignee: TourWrist, Inc., San Francisco, CA (US)

(21) Appl. No.: 13/798,048

(22) Filed: Mar. 12, 2013

Related U.S. Application Data
(60) Provisional application No. 61/667,893, filed on Jul. 3, 2012.

(51) Int. Cl. H04N 5/232

(52) U.S. Cl. CPC H04N 5/23238
USPC 348/36

(57) ABSTRACT

The present invention relates to systems and methods for efficiently storing panoramic image data with flex-focal metadata for subsequent display of pseudo three-dimensional panoramas derived from two-dimensional image sources. The panorama display system includes a camera, a processor and a display device. The camera is configured to determine a current user field of view (FOV). The processor retrieves and processes at least one image associated with a panorama together with associated flex-focal metadata in accordance with the current user FOV, and generates a current panoramic image for the display device.

### CROSS REFERENCE TO RELATED APPLICATION

This non-provisional application claims the benefit of provisional application no. 61/667,893 filed on Jul. 3, 2012, entitled “Systems and Methods for Capture and Display of Flex-Focus Panoramas”, which application is incorporated herein in its entirety by this reference.

### BACKGROUND

The present invention relates to systems and methods for efficiently storing and displaying panoramas. More particularly, the present invention relates to storing panoramic image data with focal metadata thereby enabling users to subsequently experience pseudo three-dimensional panoramas.

The increasing wideband capabilities of wide area networks and proliferation of smart devices has been accompanied by the increasing expectation of users to be able to experience three-dimensional (3D) viewing in real-time during a panoramic tour.

However, conventional techniques for storing and transmitting three-dimensional images in high resolution images require a lot of memory and bandwidth, respectively. Further, attempts at “shoot first and focus later” still images have been made, but require specialized photography equipment (for example, light field cameras having a proprietary micro-lens array coupled to an image sensor such as those from Lytro, Inc. of Mountain View, Calif.).

It is therefore apparent that an urgent need exists for efficiently storing and displaying in real-time 3-D-like panoramic images without substantially increasing storage or transmission requirements.

### SUMMARY

To achieve the foregoing and in accordance with the present invention, systems and methods for efficiently storing and displaying panoramas is provided. In particular, these systems store panoramic image data with focal metadata thereby enabling users to be able to experience pseudo three-dimensional panoramas.

In one embodiment, a panorama display system is configured to efficiently display panoramas. The display system includes a camera, a processor and a display device. The camera is configured to determine a current user FOV.

The processor is configured to retrieve at least one image associated with a panorama, and is further configured to retrieve flex-focal metadata associated with the at least one image for at least two focal distances. The processor processes the at least one image and associated flex-focal metadata in accordance with the current user FOV, and generates a current panoramic image to be displayed on the display device for the user. Determining the current FOV can include determining a current facial location of the user relative to the display device and determining a current facial orientation of the user relative to the display device.

In some embodiments, the display system is further configured to determine a current perspective of the user and generating the current panoramic image includes inferring obscured image data derived from the current perspective. The display system can also determine a current gaze of the user and wherein generating the current panoramic image includes emphasizing at least one region and object of interest. The current gaze of the user can be derived from the facial location, facial orientation and the pupil orientation of the user.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an exemplary flow diagram illustrating the capture of flex-focal images for pseudo three-dimensional viewing in accordance with one embodiment of the present invention;

FIGS. 2A and 2B illustrate in greater detail the capture of flex-focal images for the embodiment of FIG. 1;

FIG. 3A is a top view of a variety of exemplary objects (subjects) at a range of focal distances from the camera;

FIG. 3B is an exemplary embodiment of a depth map relating to the objects of FIG. 3A;

FIG. 4 is a top view of a user with one embodiment of a panoramic display system capable of detecting the user's field of view, perspective and/or gaze, and also capable of displaying pseudo 3-D panoramas in accordance with the present invention;

FIG. 5 is an exemplary flow diagram illustrating field of view, perspective and/or gaze detection for the embodiment of FIG. 4;

FIG. 6 is an exemplary flow diagram illustrating the display of pseudo 3-D panoramas for the embodiment of FIG. 4;

FIGS. 7-11 are top views of the user with the embodiment of FIG. 4, and illustrate field of view, perspective and/or gaze detection and also illustrates generating pseudo 3-D panoramas; and

FIGS. 12 and 13 illustrate two related front view perspectives corresponding to a field of view for the embodiment of FIG. 4.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

The present invention relates to systems and methods for efficiently storing panoramic image data with flex-focal metadata for subsequent display, thereby enabling a user to experience pseudo three-dimensional panoramas derived from two-dimensional image sources.

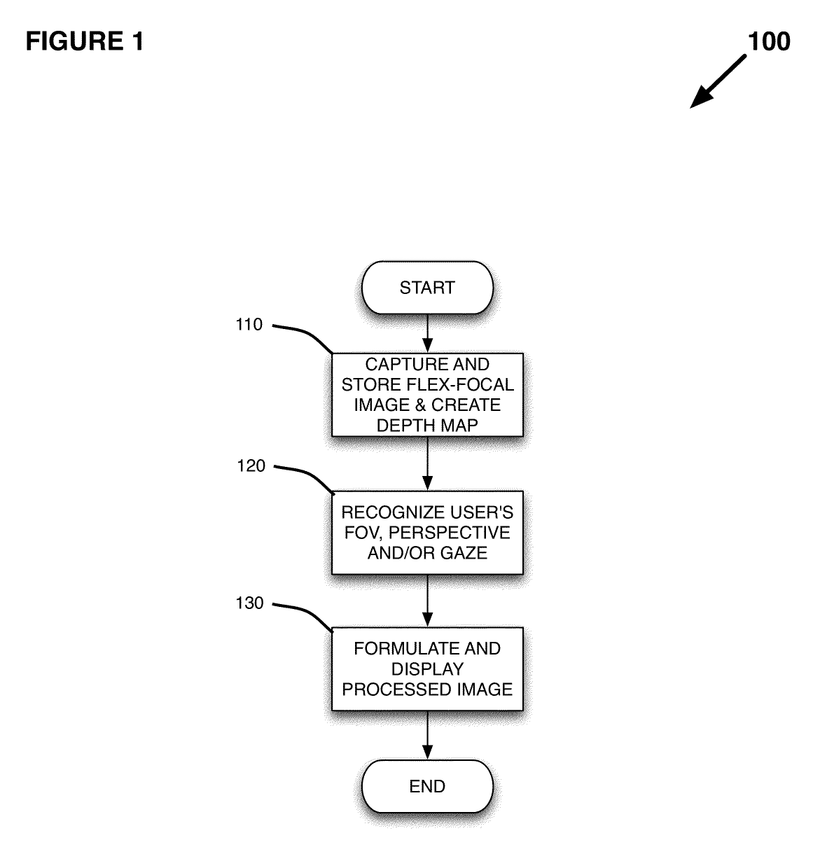

To facilitate discussion, FIG. 1 is an exemplary flow diagram 100 illustrating the capture of panoramic images for pseudo three-dimensional viewing in accordance with one embodiment of the present invention. Note that the term “perspective” is used to describe as a particular composition of an image with a defined field of view (“FOV”), wherein the FOV can be defined by one or more FOV boundaries. For example, a user's right eye and left eye see two slightly different perspectives of the same FOV, enabling the user to experience stereography. Note also that “gaze” is defined as a user's perceived region(s)/object(s) of interest.

Flow diagram 100 includes capturing and storing flex-focal image(s) with associated depth map(s) (step 110), recognizing a user's FOV, perspective, and/or gaze (step 120), and then formulating and displaying the processed image(s) for composing a panorama (step 130).

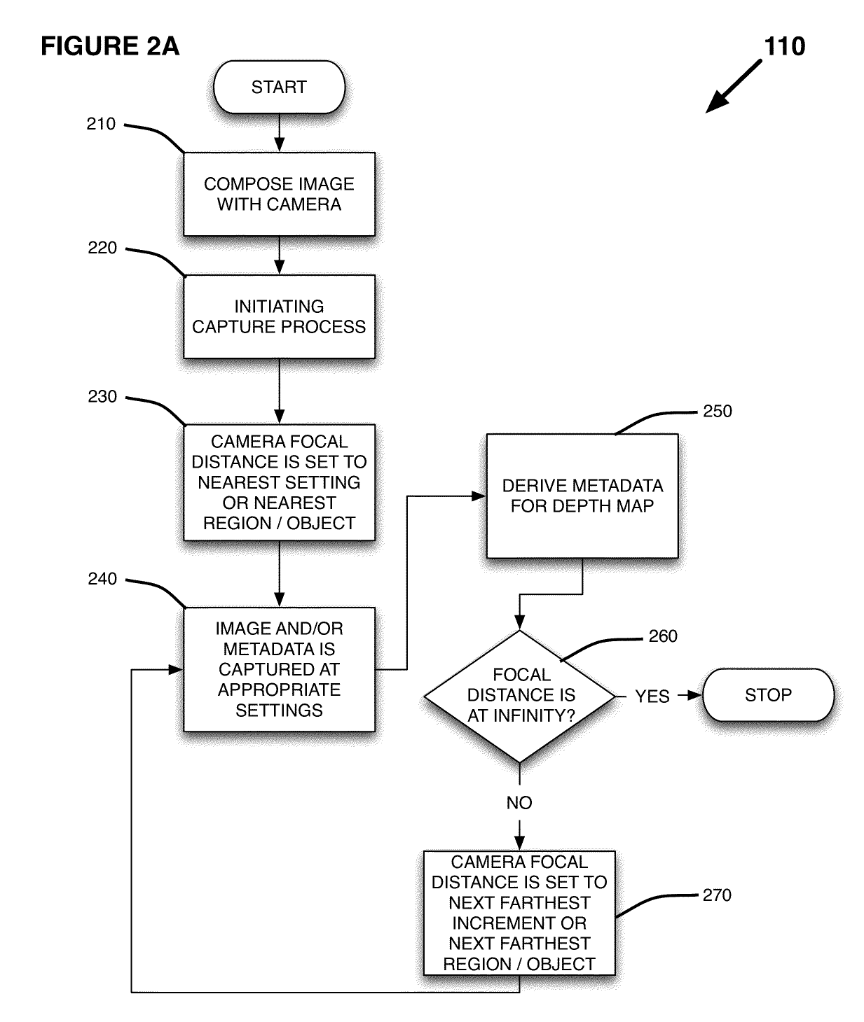

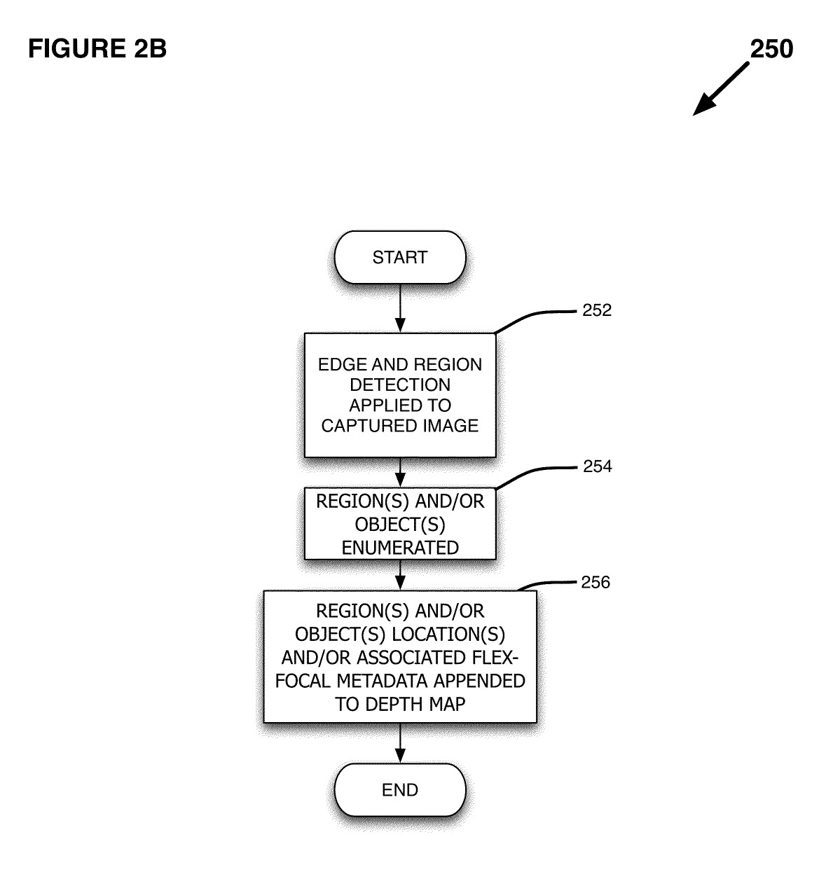

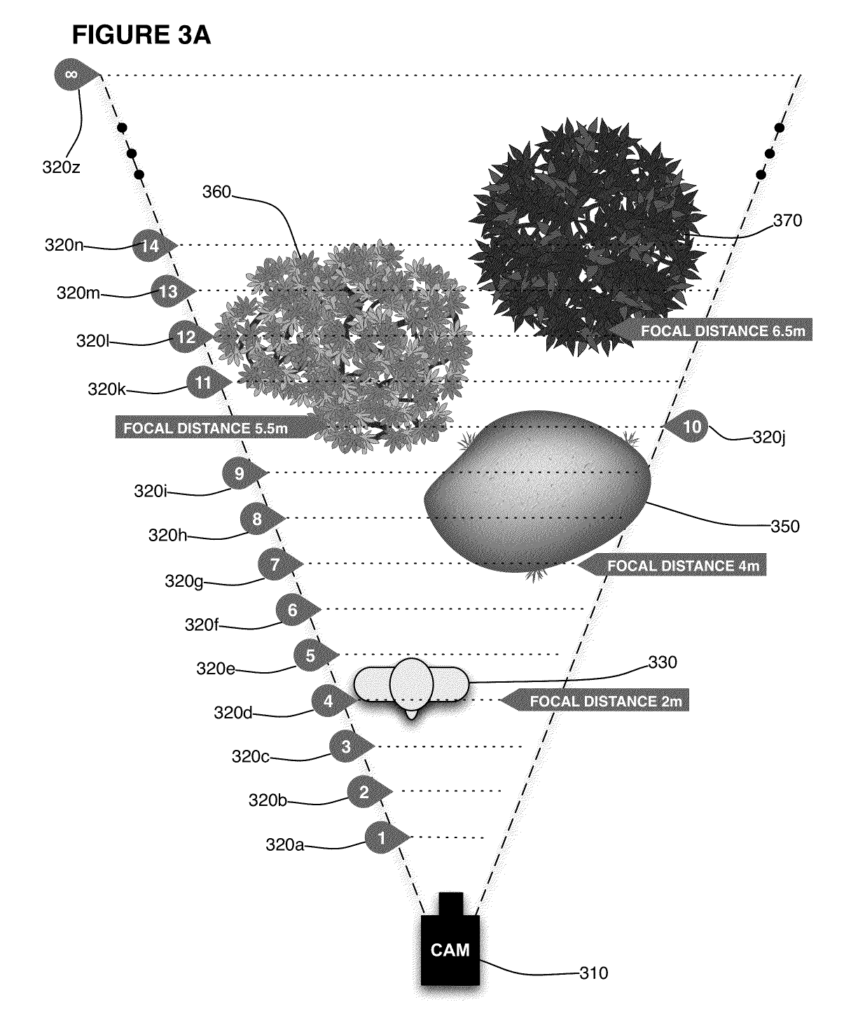

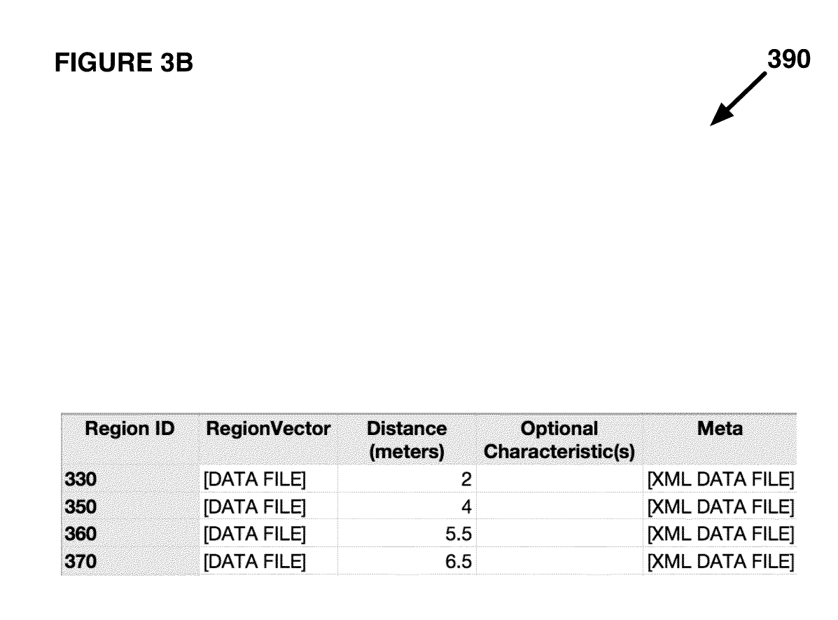

FIGS. 2A and 2B are flow diagrams detailing step 110 and illustrating the capture of flex-focal image(s) and associated depth map(s) with flex-focal metadata, while FIG. 3A is a top view of a variety of exemplary objects (also referred by photographers and videographers as “subjects”), person 330, rock 350, bush 360, tree 370 at their respective focal distances 320d, 320g, 320j, 320l from a camera 310.

FIG. 3B shows an exemplary depth map relating to the objects 330, 350, 360 and 370. Depth map 390 includes characteristics for each identified object, such as region/object ID, region/object vector, distance, opacity, color information and other metadata. Useful color information can include saturation and contrast (darkness).

In this embodiment, since most objects of interest are solid and opaque, the respective front surfaces of objects can be used for computing focal distances. Conversely, for translucent or partially transparent objects, the respective back surfaces can be used for computing focal distances. It is also possible to average focal distances of two or more appropriate surfaces, e.g., average between the front and back surfaces for objects having large, multiple and/or complex surface areas.

As illustrated by the exemplary flow diagrams of FIGS. 2A and 2B, an image is composed using camera 310 and the image capture process is initiated (steps 210, 220). In this embodiment, the focal distance (sometimes referred to as focal plane or focal field) of camera 230 is initially set to the nearest one or more regions/objects, e.g., person 330, at that initial focal distance (step 230). In step 240, the image data and/or corresponding flex-focal metadata can be captured at appropriate settings, e.g., exposure setting appropriate to the color(s) of the objects.

As shown in step 250, the flex-focal metadata is derived for a depth map associated with the image. FIG. 2B illustrates step 250 in greater detail. Potential objects (of interest) within the captured image are identified by, for example, using edge and region detection (step 252). Region(s) and object(s) can now be enumerated and hence separately identified (step 254). Pertinent region/object data such as location (e.g., coordinates), region/object size, region/object depth and/or associated region/object focal distance(s), collectively, flex-focus metadata can be appended into the depth map (step 256).

Referring back to FIG. 2A, in steps 260 and 270, if the focal distance of camera 310 is not yet set to the maximum focal distance, i.e., set to “infinity”, and then the camera focal distance is set to the next farther/farthest increment or next farther region or object, e.g., shrub 340. The process of capturing pertinent region/object data, i.e., flex-focal metadata is repeated for shrub 340 (steps 240 and 250).

This iterative cycle comprising of steps 240, 250, 260 and 270 continues until the focal distance of camera 310 is set at infinity or the region(s)/object(s) and corresponding flex-focal metadata of any remaining potential region(s)/object(s) of interest, e.g., rock 350, bush 360 and tree 370, have been captured. It should be appreciated that the number of increments for the focal distance is a function of the location and/or density of region(s)/object(s), and also the depth of field of camera 310.

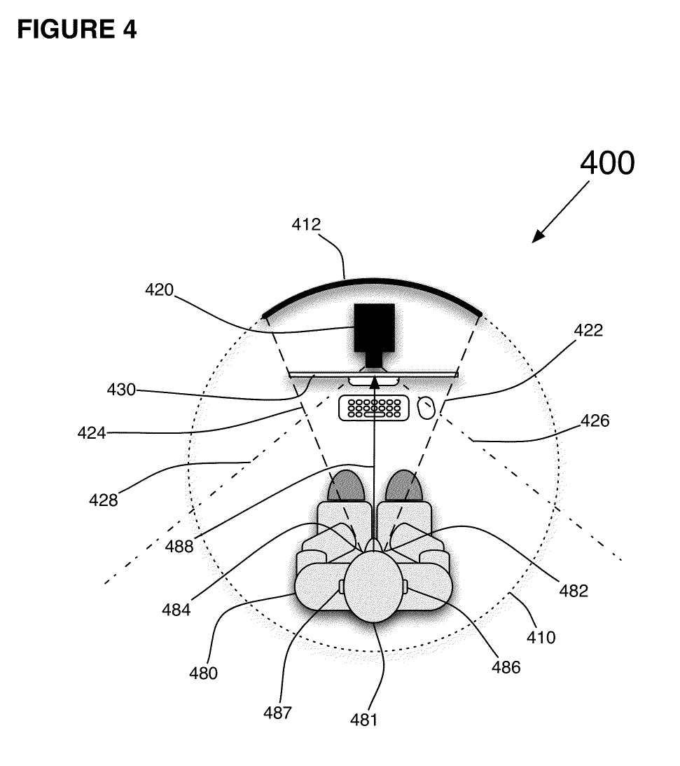

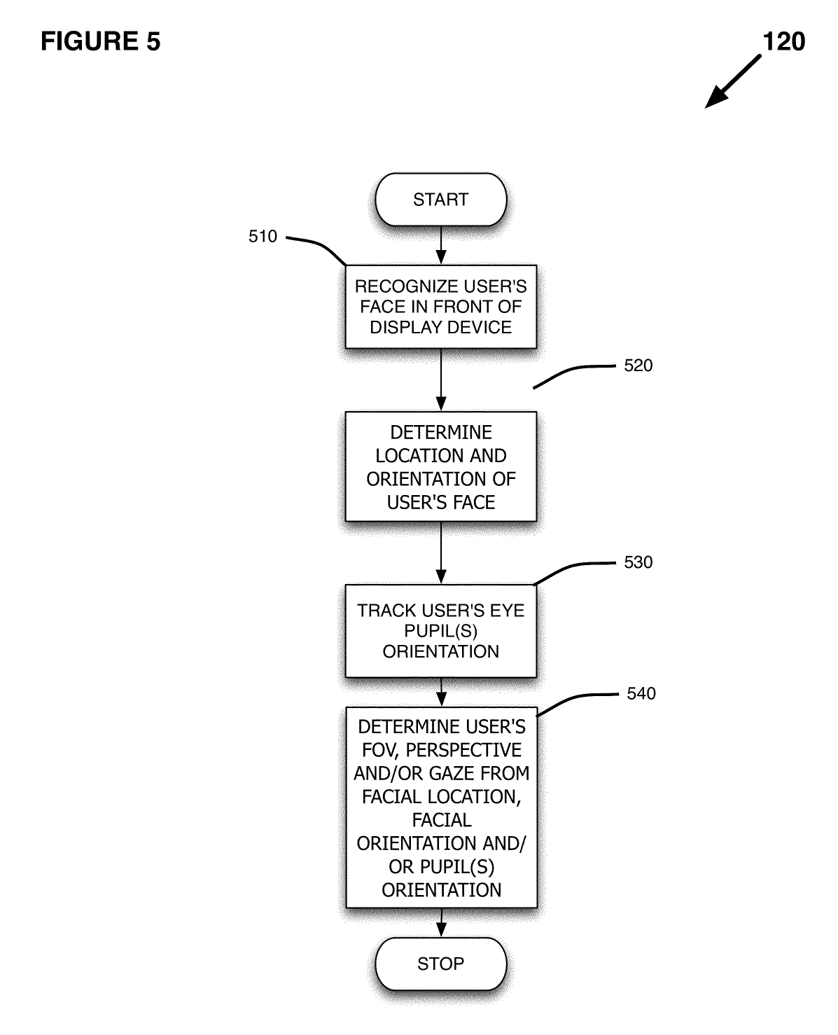

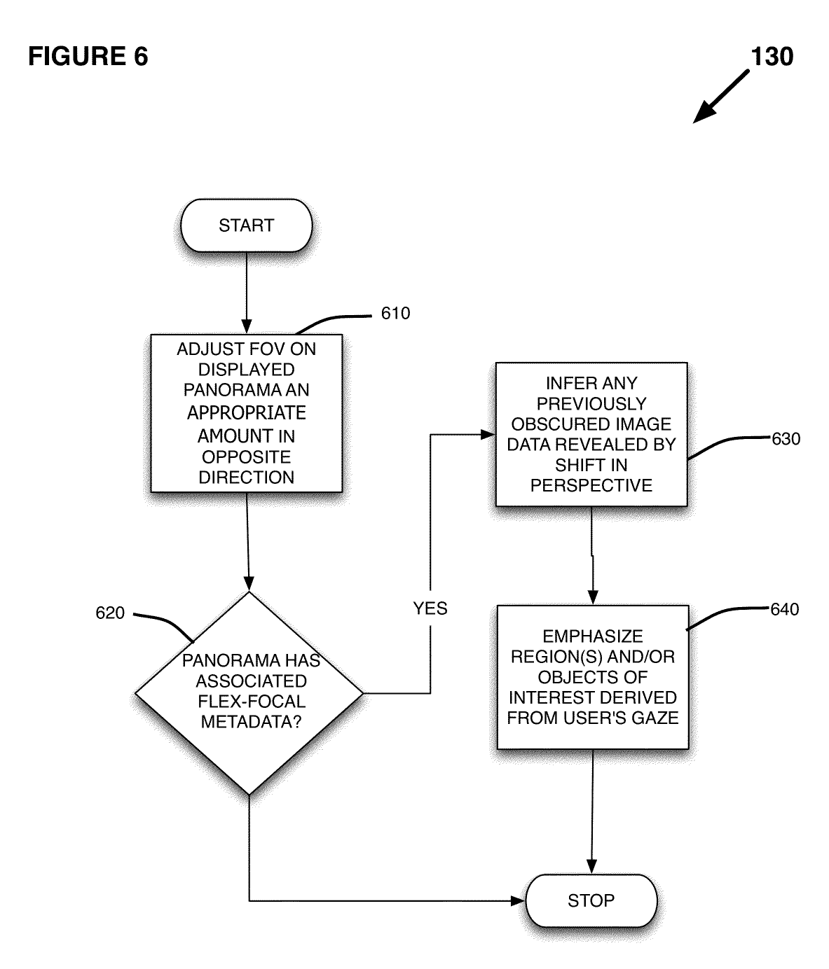

FIG. 4 is a top view of a user 480 with one embodiment of a panoramic display system 400 having a camera 420 capable of detecting a user's field of view (“FOV”), perspective and/or gaze, and also capable of displaying pseudo 3-D panoramas in accordance with the present invention. FIG. 5 is an exemplary flow diagram illustrating FOV, perspective and/or gaze detection for display system 400, while FIG. 6 is an exemplary flow diagram illustrating the display of pseudo 3-D panoramas for display system 400.

Referring to both the top view of FIG. 4 and the flow diagram of FIG. 5, camera 420 has an angle of view (“AOV”) capable for detecting user 480 between AOV boundaries 426 and 428. Note that AOV of camera 420 can be fixed or adjustable depending on the implementation.

Using facial recognition techniques known to one skilled in the art, camera 420 identifies facial features of user 480 (step 510). The location and/or orientation of user's head 481 relative to a neutral position can now be determined, for example, by measuring the relative distances between facial features and/or orientation of protruding facial features such as nose and ears 486, 487 (step 520).

In this embodiment, in addition to measuring the absolute and/or relative locations and/or orientations of user's eyes with respect to the user's head 481, the camera 420 can also measure the absolute and/or relative locations and/or orientations of user's pupils with respect to the user's head 481 and/or user's eye sockets (step 530).

Having determined the location and/or orientation of the user's head and/or eyes as described above, display system 400 can now compute the user's expected field of view 412 (“FOV”), as defined by FOV boundaries 422, 424 of FIG. 4 (step 540).

In this embodiment, having determined the location and/or orientation of the user's head, eyes, and/or pupils, display system 400 can also compute the user's gaze 488 (see also step 540). The user's gaze 488 can in turn be used to derive the user's perceived region(s)/object(s) of interest by, for example, triangulating the pupils' perceived lines of sight.

Referring now to the top view of FIG. 4 and the flow diagram of FIG. 6, the user's expected FOV 412 (defined by boundaries 422, 424), perspective and/or perceived region(s)/object(s) of interest have (derived from gaze 488) have been determined in the manner described above. Accordingly, the displayed image(s) for the panorama can be modified to accommodate the user's current FOV 412, current perspective and/or current gaze 488, thereby providing the user with a pseudo 3-D viewing experience as the user 480 moves his head 481 and/or eye pupils 482, 484.

In step 610, the display system 400 adjust the user's FOV 412 of the displayed panorama an appropriate amount in the appropriate, e.g., opposite, direction relative to the movement of user's head 481 and eyes.

If the to-be-displayed panoramic image(s) are associated with flex-focal metadata (step 620), then system 400 provides user 480 with the pseudo 3-D experience by inferring e.g., using interpolation, extrapolation, imputation and/or duplication, any previously obscured image data exposed by any shift in the user's perspective (step 630).

In some embodiments, display system 400 may also emphasize region(s) and/or object(s) of interest derived from the user's gaze by, for example, focusing the region(s) and/or object(s), increasing the intensity and/or the resolution of the region(s) and/or object(s), and/or decreasing the intensity and/or the resolution of the region(s) and/or object(s), and/or defocusing the foreground /background of the image (step 640).

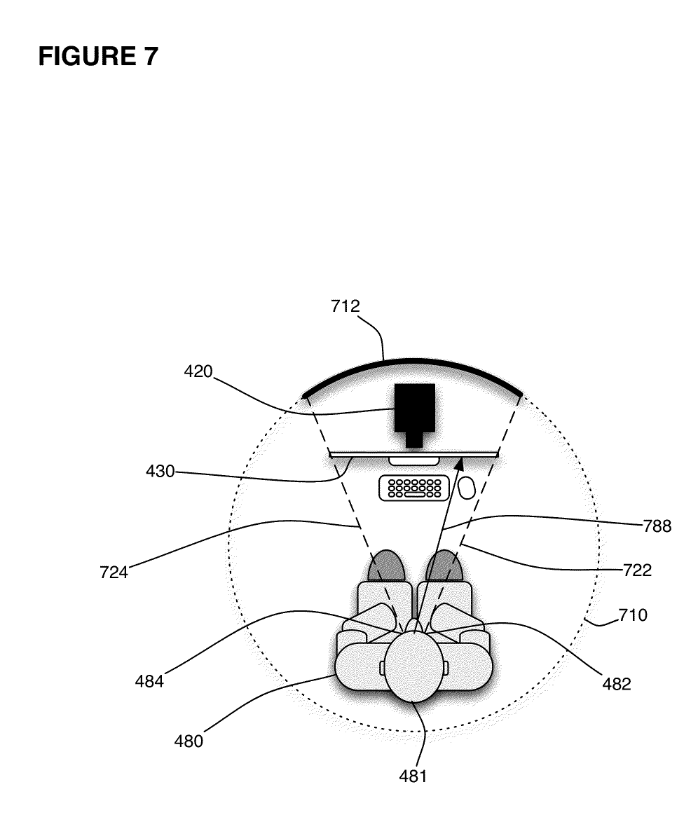

FIGS. 7-11 are top views of the user 480 with display system 400, and illustrate FOV, perspective and/or gaze detection for generating pseudo 3-D panoramas. Referring first to FIG. 7, camera 340 determines that the user's head 481 and nose are both facing straight ahead. However the user's pupils 482, 484 are rotated rightwards within their respective eye sockets. Accordingly, the user's resulting gaze 788 is offset towards the right of the user's neutral position.

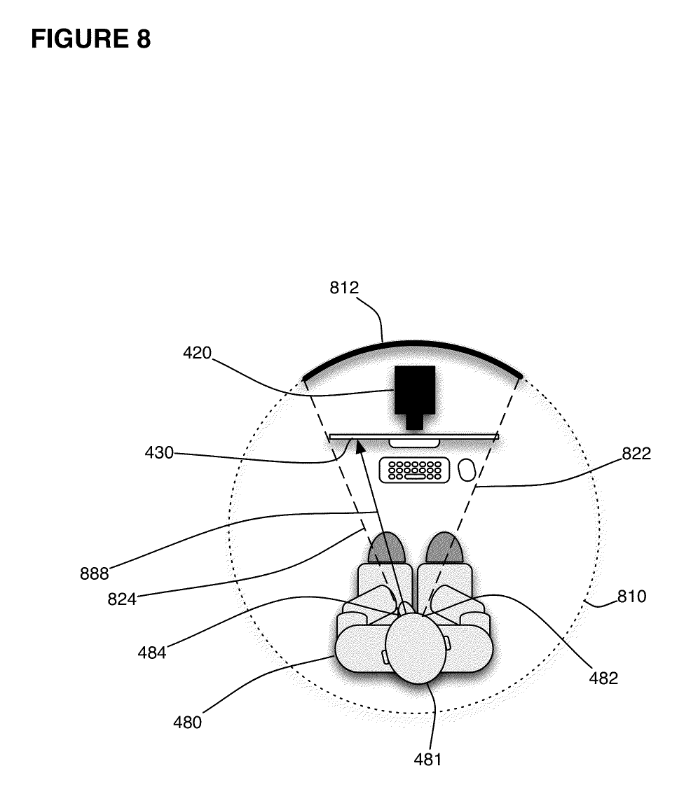

In FIG. 8, the user's head 481 is facing leftwards, while the user's pupils 782, 784 are a neutral position relative to their respective eye sockets. Hence, the user's resulting gaze 888 is offset toward the left of the user's neutral position.

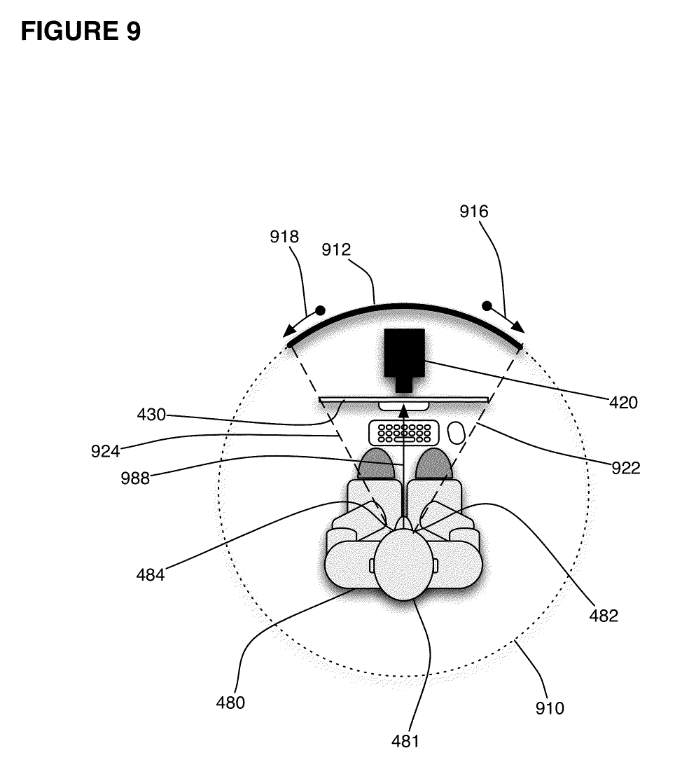

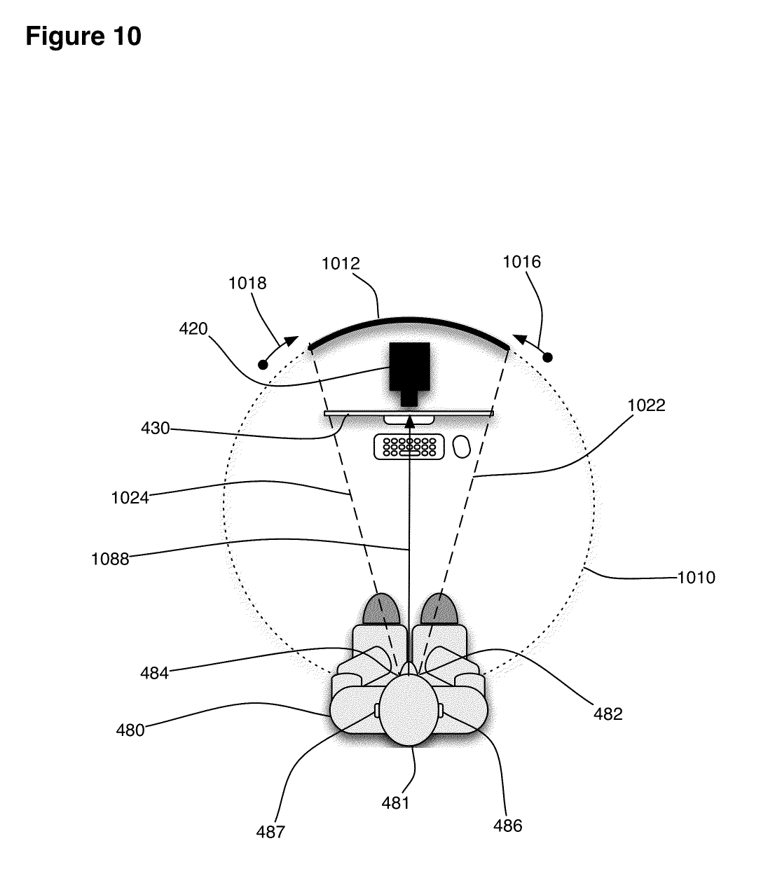

FIGS. 9 and 10 illustrate the respective transitions of the field of view (FOV) provided by display 430 whenever the user 480 moves towards and away from display 430. For example, when user 480 moves closer to display 430 as shown in FIG. 9, the FOV 912 increases (see arrows 961, 918) along with the angle of view as illustrated by the viewing boundaries 922, 924. Conversely, as shown in FIG. 10 when user 480 moves further away from display 430, the FOV 1012 decreases (see arrows 1016, 1018) along with the angle of view as illustrated by the viewing boundaries 1022, 1024. In both examples, user gazes 988, 1088 are in the neutral position.

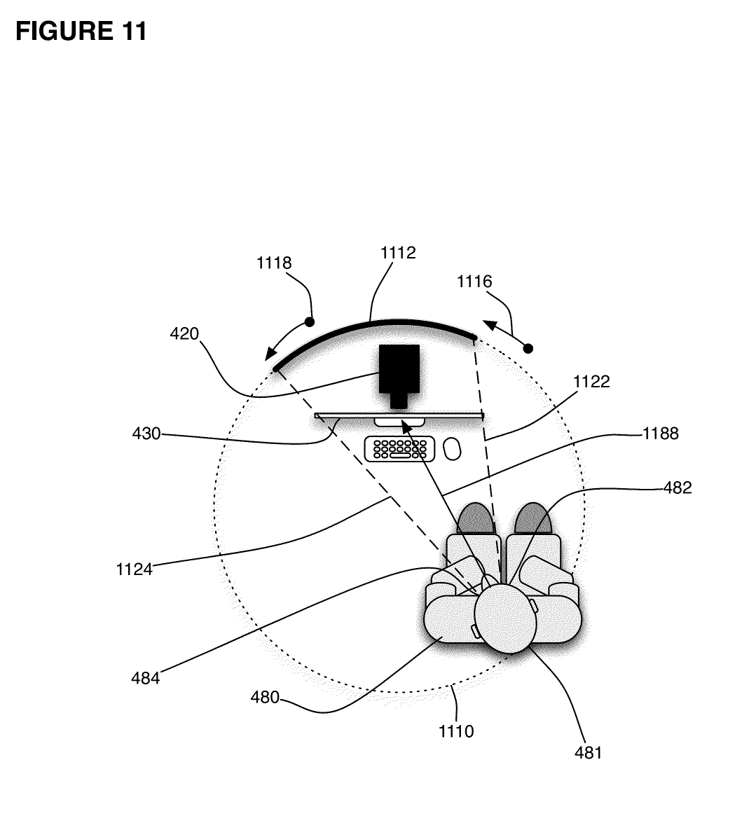

It is also possible for user 480 to move laterally relative to display 430. Referring to exemplary FIG. 11, as user 480 moves laterally toward the user's right shoulder and turns head 418 towards the left shoulder. As a result, the FOV 1112 is shifted towards the left (see arrows 1116, 1118) as illustrated by viewing boundaries 1122, 1124. In this example, user gaze 1188 is also in the neutral position.

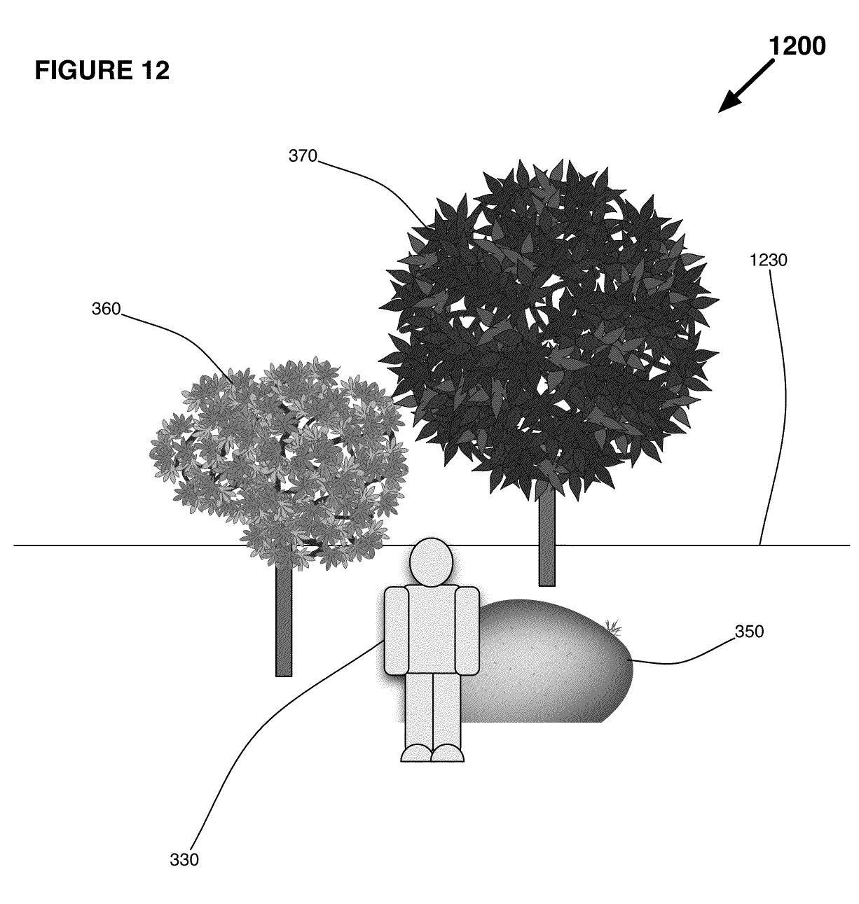

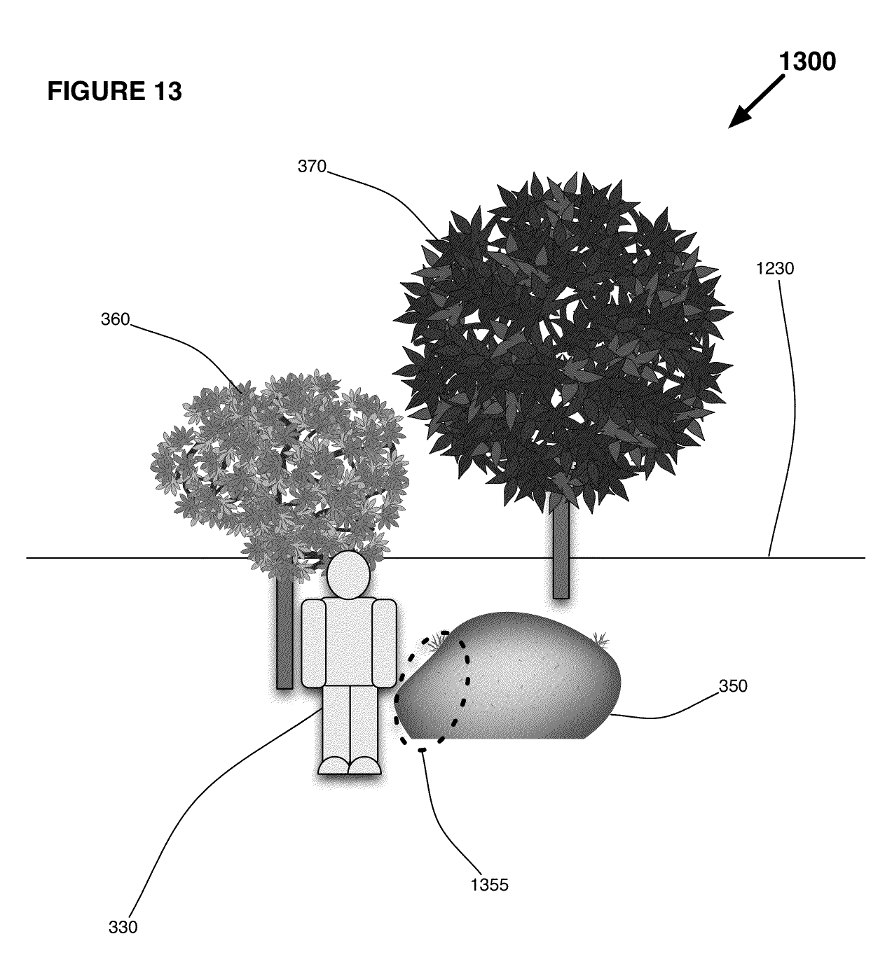

FIGS. 12 and 13 show an exemplary pair of related front view perspectives 1200, 1300 corresponding to a user's field of view, thereby substantially increasing the perception of 3-D viewing of a panorama including objects of interest, person 330, rock 350, bush 360, tree 370 (see FIG. 3A). In this example, as illustrated by FIG. 11, when viewing user 480 moves laterally towards the user's right shoulder, the change in perspective (and/or FOV) can result in the exposure of a portion 1355 of rock 350 as shown in FIG. 13, which had been previously obscured by person 330 as shown in FIG. 12. The exposed portion 1355 of rock 350 can be inferred in the manner described above.

Many modifications and additions are also possible. For example, instead of a single camera 420, system 400 may have two or more strategically located cameras which should increase to accuracy and possibly speed of determining FOV, perspective and/or gaze of user 480.

It is also possible to determine FOV, perspective and/or gaze using other methods such as using the user's finger(s) as a joystick, or using a pointer as a joystick. It should be appreciated that various representations of flex-focal metadata are also possible, including different data structures such as dynamic or static tables, and vectors.

In sum, the present invention provides systems and methods for capturing flex-focal imagery for pseudo three-dimensional panoramic viewing. The advantages of such systems and methods include enriching the user viewing experience without the need to also substantially increasing bandwidth capability and storage capacity.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for efficiently storing panoramas, useful in association with a camera, the method comprising:
capturing at least one image associated with a panorama; and
capturing flex-focal metadata associated with the at least one image for at least two focal distances.

2. The method of claim 1 further comprising:
retrieving the at least one image associated with the panorama;
retrieving flex-focal metadata associated with the at least one image; and
while a user is viewing the panorama on a display device:
determining a current user field of view (FOV);
processing the at least one image and associated flex-focal metadata in accordance with the current user FOV and generating a current panoramic image; and
displaying the current panoramic image on the display device.

3. The method of claim 2 wherein determining the current FOV includes while a user is viewing a panorama on the display device:
determining a current facial location of the user relative to the display device;
determining a current facial orientation of the user relative to the display device; and
wherein determining the current FOV of the user is based on the facial location and the facial orientation of the user.

4. The method of claim 2 further comprising determining a current perspective of the user and wherein generating the current panoramic image includes inferring obscured image data derived from the current perspective.

5. The method of claim 2 further comprising determining a current gaze of the user and wherein generating the current panoramic image includes emphasizing at least one region and object of interest.

6. The method of claim 5 wherein determining the current gaze includes:
determining the current facial location of the user relative to the display device;
tracking at least one current pupil orientation of the user relative to the display device; and
wherein the gaze base is derived from the facial location and the pupil orientation of the user.

7. A computerized method for efficiently displaying panoramas, useful in association with a panoramic display device, the method comprising:
retrieving at least one image associated with a panorama;
retrieving flex-focal metadata associated with the at least one image for at least two focal distances; and
while a user is viewing the panorama on a display device:
determining a current user FOV;
processing the at least one image and associated flex-focal metadata in accordance with the current user FOV and generating a current panoramic image; and
displaying the current panoramic image on the display device.

8. The method of claim 7 wherein determining the current FOV includes while a user is viewing a panorama on the display device:
determining a current facial location of the user relative to the display device;
determining a current facial orientation of the user relative to the display device; and
wherein determining the current FOV of the user is based on the facial location and the facial orientation of the user.

9. The method of claim 7 further comprising determining a current perspective of the user and wherein generating the current panoramic image includes inferring obscured image data derived from the current perspective.

10. The method of claim 7 further comprising determining a current gaze of the user and wherein generating the current panoramic image includes emphasizing at least one region and object of interest.

11. The method of claim 7 wherein determining the current gaze includes:
determining the current facial location of the user relative to the display device;
tracking at least one current pupil orientation of the user relative to the display device; and
wherein the gaze base is derived from the facial location and the pupil orientation of the user.

12. A panoramic server configured to efficiently store panoramas, useful in association with a camera, the server comprising:
a database configured to store at least one image associated with a panorama captured by a camera; and
wherein the database is further configured to store flex-focal metadata associated with the at least one image for at least two focal distances.

13. A panorama display system configured to efficiently display panoramas, the display system comprising:
a camera configured to determine a current user FOV;
a processor configured to retrieve at least one image associated with a panorama, the processor further configured to retrieve flex-focal metadata associated with the at least one image for at least two focal distances, and wherein the processor is further configured to process the at least one image and associated flex-focal metadata in accordance with the current user FOV and to generate a current panoramic image; and
a display device configured to display the current panoramic image.

14. The display system of claim 13 wherein determining the current FOV includes while a user is viewing a panorama on the display device:
determining a current facial location of the user relative to the display device;
determining a current facial orientation of the user relative to the display device; and
wherein determining the current FOV of the user is based on the facial location and the facial orientation of the user.

15. The display system of claim 13 wherein the processor is further configured to determine a current perspective of the user and wherein generating the current panoramic image includes inferring obscured image data derived from the current perspective.

16. The display system of claim 13 further comprising determining a current gaze of the user and wherein generating the current panoramic image includes emphasizing at least one region and object of interest.

17. The display system of claim 16 wherein determining the current gaze includes:
determining the current facial location of the user relative to the display device;
tracking at least one current pupil orientation of the user relative to the display device; and
deriving the current gaze from the facial location and the pupil orientation of the user.

18. The display system of claim 14 wherein determining the current FOV is also based on at least one current pupil orientation of the user relative to the display system.
